(19) United States
(12) Patent Application Publication
(10) Pub. No.: US 2015/0209956 A1
(43) Pub. Date: Jul. 30, 2015

(54) HAND TOOL DISPLAY HANGER

(71) Applicant: GONG FONG ENTERPRISE CO., LTD., Tainan City (TW)

(72) Inventor: CHENG-TE HU, TAINAN CITY (TW)

(73) Assignee: GONG FONG ENTERPRISE CO., LTD., Tainan City (TW)

(21) Appl. No.: 14/166,968

(22) Filed: Jan. 29, 2014

(51) Int. Cl. B25H 3/00; B65D 73/00

(52) U.S. Cl. CPC B25H 3/006; B65D 73/0064

(57) ABSTRACT

A hand tool display hanger includes a hanger body and a fixing base. The hanger body contains a fixing portion. The fixing portion has a receiving space, a through hole, a first engaging portion, an access opening, a first stop block, and a first blocking portion, wherein the through hole and the access opening communicate with the receiving space. The fixing base is fixed in the receiving space and is provided with an insertion hole, a second engaging portion, a second blocking portion, and a second stop block, the latter three of which are respectively engaged with the first engaging portion, the first stop block, and the first blocking portion to prevent the fixing base from falling out of the fixing portion. The display hanger can be rapidly assembled, and a hand tool can be inserted in the insertion hole to achieve a visually pleasing, anti-theft display.

### BACKGROUND OF THE INVENTION

1. Technical Field

The present invention relates to hand tool display hangers and, more particularly, to a hand tool display hanger which can be rapidly assembled for a visually pleasing display, which has multiple engaging/blocking features, and which can hinder unauthorized removal of the hand tool fixed therein.

2. Description of Related Art

To facilitate transaction, hand tools for sale are generally fixed on display hangers for display. The structure of such display hangers is disclosed in Taiwan Utility Model Patent No. M436401, issued on Sep. 1, 2012 and titled “Display Base for Precision Tools”, wherein the display base includes a display unit and a connecting mechanism and can be converted between a planar display position and a three-dimensional display position. The display unit includes two spaced-apart lateral display panels on which precision tools can be disposed. The display unit also includes at least one connecting display panel which is flexibly connected between the lateral display panels and on which precision tools can be disposed. The connecting mechanism is provided on the lateral display panels of the display unit and is disengageably connected to the lateral display panels when the display base is in the three-dimensional display position. The display base is switchable between the three-dimensional display position and the planar display position as desired and therefore provides flexibility in display.

While the afore-cited '401 patent allows a plurality of hand tools to be simultaneously disposed on the lateral display panels, the manufacture and assembly of the display base are time-consuming and hence costly. Esthetically speaking, the display base is also wanting. As such, the display base leaves much to be desired in use.

Taiwan Utility Model Patent No. M431789, issued on Jun. 21, 2012 and titled “Anti-Theft Tool Accessory Bracket Device”, discloses fitting a tool accessory tightly between lateral fasteners to effectively achieve hanging display and theft prevention. The bracket device includes a tool accessory bracket body and an anti-theft position-limiting module. To use, a tool accessory is connected to the tool accessory bracket body. Then, a position-limiting cover plate and a position-limiting base of the position-limiting module are connected together from two lateral sides of the tool accessory such that the tool accessory is tightly fitted in the bracket device. Meanwhile, the ribs provided on the inner periphery of the position-limiting cover plate and of the position-limiting base are engaged in a groove in the tool accessory to secure the tool accessory between the position-limiting cover plate and the position-limiting base.

The '789 patent can accommodate a plurality of tool accessories at the same time, too, but its utility is likewise compromised by the time-consuming and costly manufacture and assembly processes and the lack of a pleasing look.

### BRIEF SUMMARY OF THE INVENTION

In view of the aforesaid drawbacks of the existing hand tool display hanger structures, the present invention provides a hand tool display hanger as disclosed herein. The hand tool display hanger includes a hanger body and a fixing base. The hanger body is provided with a fixing portion. The fixing portion is provided with a receiving space. The fixing portion is also provided with a through hole in communication with the receiving space and a first engaging portion at the periphery of the through hole. The fixing portion is further provided with an access opening in communication with the receiving space, a first stop block adjacent to the access opening, and a first blocking portion adjacent to the access opening. The fixing base, which is fixed in the receiving space of the hanger body, is provided with an insertion hole. Also, the fixing base is provided with a second engaging portion corresponding in position to and engaged with the first engaging portion. The fixing base is further provided with a second blocking portion engaged with the first stop block, and a second stop block engaged with the first blocking portion. A hand tool whose diameter is larger than the diameter of the insertion hole can be tightly held in the insertion hole and, once so, is difficult to be pulled out.

A top portion and a bottom portion of the fixing portion each have the through hole disposed thereon. The access opening is provided at the back of the fixing portion. Two opposite lateral sides of the access opening each have the first stop block disposed thereon. The first blocking portion extends from an upper edge of the access opening.

A top portion and a bottom portion of the fixing base each have the second engaging portion disposed thereon. Two opposite lateral sides of the back of the fixing base each have the second blocking portion formed thereon. The second stop block is provided at an upper edge of the back of the fixing base.

The first engaging portion is a protruding block having an L-shaped cross section. The second engaging portion is a recess having an L-shaped cross-section so as to engage with one of the protruding block.

The front side of the fixing portion has a first slot transversely formed thereon, and the front side of the fixing base has a second slot transversely formed thereon. The second slot corresponds in position to the first slot.

The hanger body is provided with a hanging hole.

The fixing base is an elastic block.

The shape of the fixing base matches the shape of the receiving space.

The maximum dimension of the fixing base is larger than the maximum dimension of the access opening.

The cross-sectional shape of the insertion hole is different from the cross-sectional shape of the hand tool so that the hand tool can be tightly held in the insertion hole. The cross section of the insertion hole is circular, rectangular, pentagonal, hexagonal, or diamond-shaped.

The present invention has the following advantages:

1. The present invention is structurally simple and can be rapidly put together to reduce the time and cost of assembly. Moreover, the hand tool display hanger of the present invention is visually pleasing when in display, which adds to its commercial value.

2. In the present invention, the second engaging portion, the second blocking portion, and the second stop block of the fixing base are respectively engaged with the first engaging portion, the first stop block, and the first blocking portion of the fixing portion of the hanger body to produce multiple engaging/blocking effects, thereby preventing the fixing base from coming out of the fixing portion.

3. A hand tool inserted in the insertion hole of the fixing base of the present invention is tightly held against arbitrary removal.

### BRIEF DESCRIPTION OF THE SEVERAL VIEWS OF THE DRAWINGS

The structure and further advantages of the present invention will be best understood by referring to the following detailed description of an illustrative embodiment in conjunction with the accompanying drawings, in which:

FIG. 1 is an exploded perspective view of a preferred embodiment of the present invention;

FIG. 2 is an exploded perspective view of the preferred embodiment of the present invention taken from another viewing angle;

FIG. 3 is an assembled perspective view of the preferred embodiment of the present invention;

FIG. 4 is a perspective view showing a hand tool being tightly held by the preferred embodiment of the present invention;

FIG. 5 is an assembled sectional view of the preferred embodiment of the present invention; and

FIG. 6 is an assembled sectional view of the preferred embodiment of the present invention taken from another viewing angle.

### DETAILED DESCRIPTION OF THE INVENTION

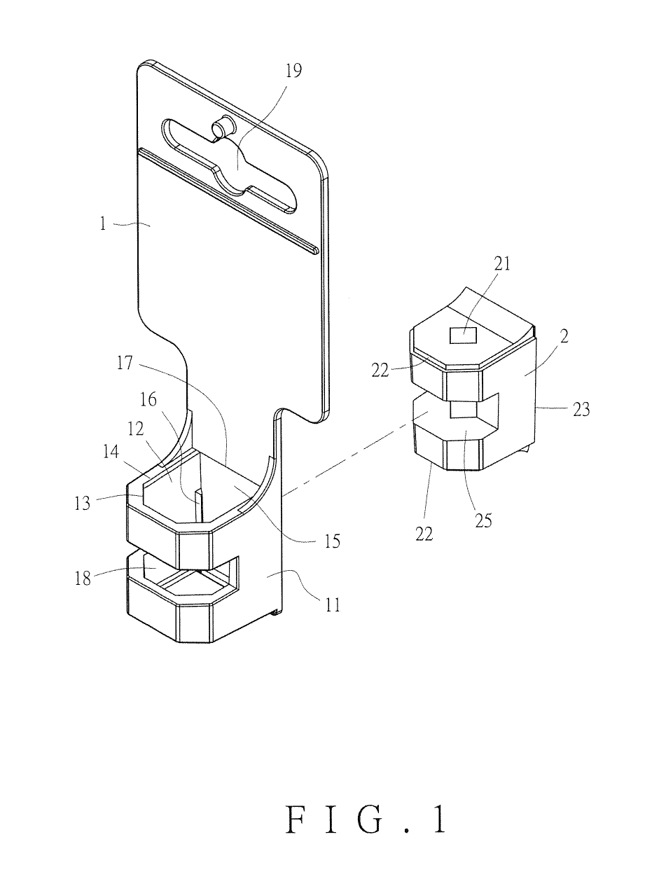

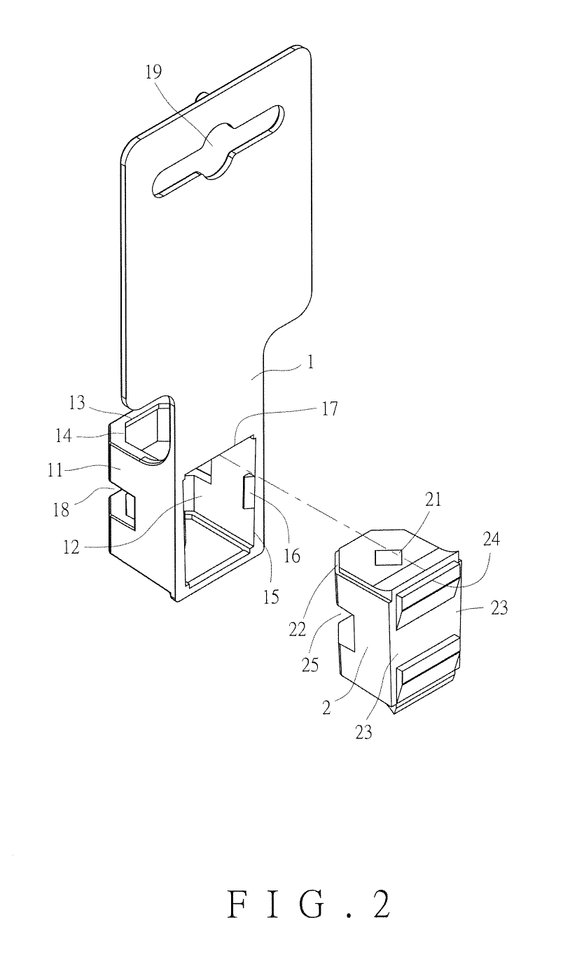

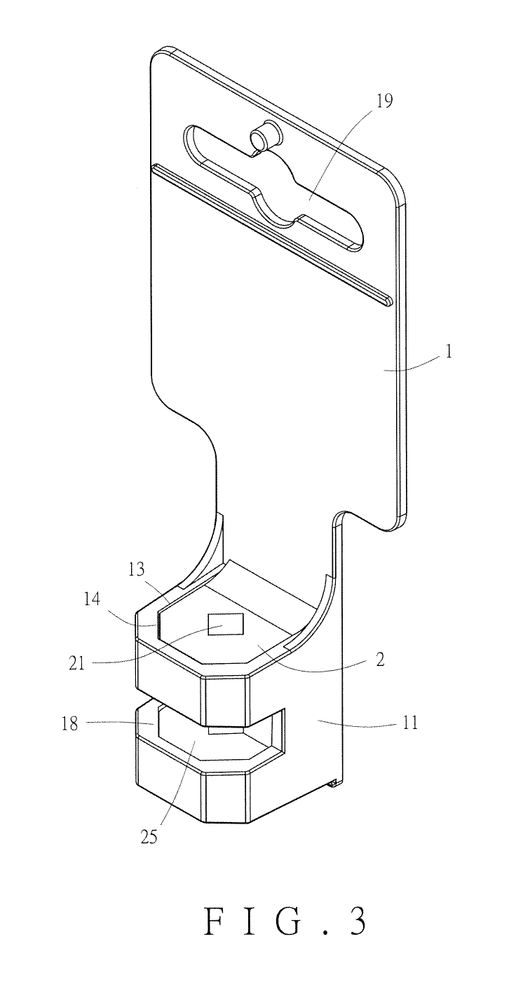

Referring to FIG. 1 through FIG. 3, an embodiment of the present invention includes a hanger body I and a fixing base 2.

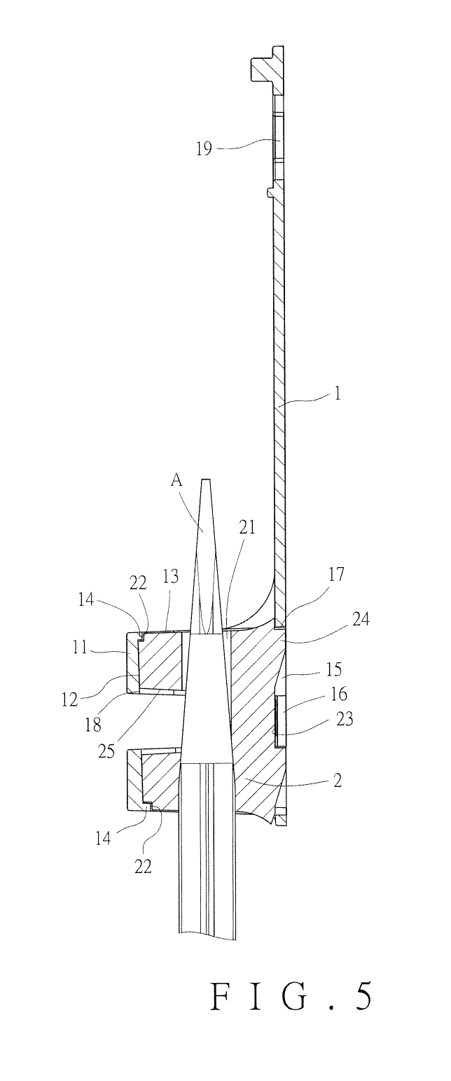

The hanger body 1 is provided with a fixing portion 11. The fixing portion 11 is provided therein with a receiving space 12 (see FIG. 5). A through hole 13 in communication with the receiving space 12 is provided at each of a top portion and a bottom portion of the fixing portion 11. The periphery of each of the two through holes 13 of the fixing portion 11 is protrudingly provided with a first engaging portion 14, wherein each of the two first engaging portions 14 is a protruding block having an L-shaped cross section. Also, the back of the fixing portion 11 is provided with an access opening 15 in communication with the receiving space 12. The fixing portion 11 is further provided with a first stop block 16 at each of two opposite lateral sides of the access opening 15. An upper edge of the access opening 15 is provided with a transverse first blocking portion 17. The front side of the fixing portion 11 is transversely formed with a first slot 18. An upper edge of the hanger body 1 is provided with a hanging hole 19.

The fixing base 2 is fixed in the receiving space 12 of the fixing portion 11. The fixing base 2 is an elastic block made of rubber and capable of elastic compression. Moreover, the fixing base 2 matches the receiving space 12 in shape and has a maximum dimension slightly larger than the maximum dimension of the access opening 15 of the fixing portion 11. The fixing base 2 is longitudinally formed with an insertion hole 21 whose cross section is circular, rectangular, pentagonal, hexagonal, or diamond-shaped. Further, a top portion and a bottom portion of the fixing base 2 are each provided with a second engaging portion 22, wherein the two second engaging portions 22 correspond in position to the first engaging portions 14 respectively. Each of the second engaging portions 22 is a recess having an L-shaped cross section in order to engage with one of the first engaging portions 14. A second blocking portion 23 is provided at each of two lateral sides of the back of the fixing base 2. The second blocking portions 23 are configured to engage with the first stop blocks 16 respectively and thereby produce a blocking effect. An upper edge of the back of the fixing base 2 is at least protrudingly provided with a second stop block 24. The second stop block 24 is configured to engage with the first blocking portion 17 and thereby produce a blocking effect. The front side of the fixing base 2 is further transversely formed with a second slot 25 corresponding in position to the first slot 18.

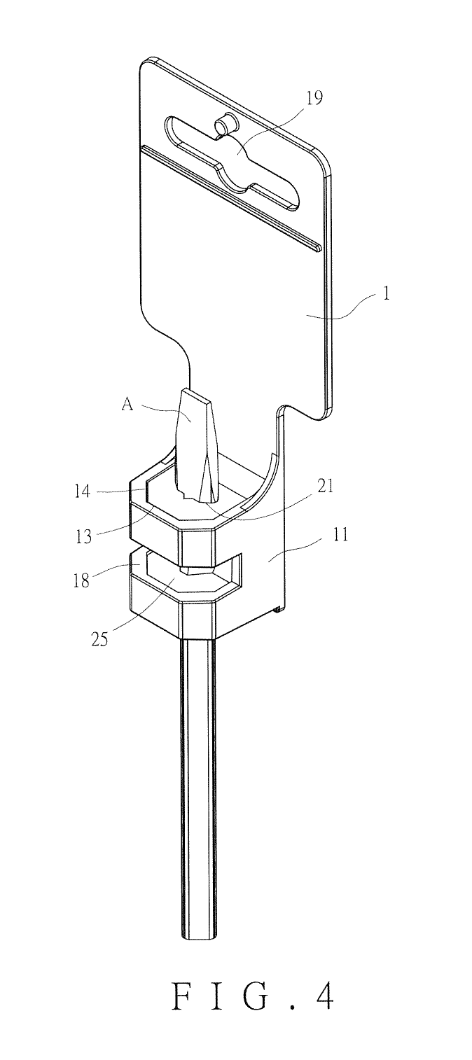

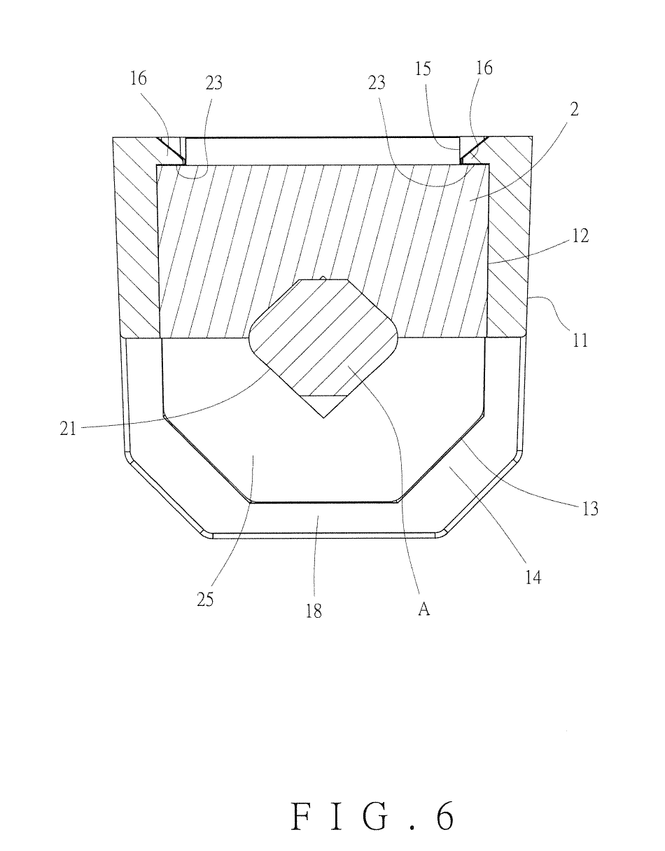

To assemble for use, referring to FIG. 1 to FIG. 3, the fixing base 2 is forced into the access opening 15 of the fixing portion 11 of the hanger body 1. In spite of the fact that the maximum dimension of the fixing base 2 is slightly larger than the maximum dimension of the access opening 15 of the fixing portion 11, it is the elastic compression of the rubber material of which the fixing base 2 is made that allows the fixing base 2 to be fitted into the receiving space 12, with the second engaging portions 22 at the top portion and the bottom portion of the fixing base 2 respectively engaged with the first engaging portions 14 (as can be seen more clearly in FIG. 5). Due to the engaging effect of the two first engaging portions 14, the fixing base 2 is positioned in the receiving space 12 of the fixing portion 11 and will not come out of the through hole 13 at each of the top portion and the bottom portion of the fixing portion 11. Meanwhile, the second blocking portions 23 at the back of the fixing base 2 are respectively engaged with the first stop blocks 16 at the two lateral sides of the access opening 15 of the fixing portion 11 (see FIG. 6) to produce a blocking effect, and the second stop block 24 at the back of the fixing base 2 is engaged with the first blocking portion 17 at the access opening 15 of the fixing portion 11 to produce a further blocking effect. The multiple engaging/blocking effects prevent the fixing base 2 from falling out through the access opening 15 or the two through holes 13 of the fixing portion 11. In other words, the fixing base 2 is now tightly fitted in the receiving space 12. Then, a hand tool A is inserted into the insertion hole 21 of the fixing base 2 (see FIG. 4). As the diameter of the hand tool A is larger than the diameter of the insertion hole 21, or as the cross-sectional shape of the hand tool A is different from the cross-sectional shape of the insertion hole 21, the hand tool A is tightly held in the insertion hole 21 and cannot be easily pulled out from the insertion hole 21 of the fixing base 2. Since the fixing base 2 itself cannot be easily removed from the receiving space 12, either, the hand tool A is kept from arbitrary removal. Besides, whether the hand tool A is properly held in place can be observed through the first slot 18 and the second slot 25. In short, the overall structure of the present invention is rather simple and can be rapidly fitted together to reduce the time and cost of assembly. When displayed, the hand tool display hanger of the present invention is esthetically pleasing and hence has high commercial value.

The embodiment described above is only one embodiment of the present invention and should not be construed as restrictive of the scope of patent protection sought. All simple and equivalent changes and substitutions based on the claims and description of the present invention should fall within the scope of the appended claims.

What is claimed is:

1. A hand tool display hanger, comprising:
a hanger body provided with a fixing portion, the fixing portion being provided with:
a receiving space, a through hole in communication with the receiving space, a first engaging portion at a periphery of the through hole, an access opening in communication with the receiving space, a first stop block adjacent to the access opening, and a first blocking portion adjacent to the access opening;
a fixing base fixed in the receiving space of the fixing portion, the fixing base being provided with: an insertion hole, a second engaging portion corresponding in position to and engaged with the first engaging portion, a second blocking portion engaged with the first stop block, and a second stop block engaged with the first blocking portion;
wherein the hand tool display hanger is adapted for holding a hand tool which is larger in diameter than the insertion hole of the fixing base such that the hand tool can be tightly held in the insertion hole.

2. The hand tool display hanger of claim 1, wherein a top portion and a bottom portion of the fixing portion each have the through hole disposed thereon, the access opening is provided at a back of the fixing portion, two opposite lateral sides of the access opening each have the first stop block disposed thereon, and the first blocking portion extends from an upper edge of the access opening.

3. The hand tool display hanger of claim 1, wherein a top portion and a bottom portion of the fixing base each have the second engaging portion disposed thereon, two opposite lateral sides of a back of the fixing base each have the second blocking portion formed thereon, and the second stop block is provided at an upper edge of the back of the fixing base.

4. The hand tool display hanger of claim 1, wherein the first engaging portion is a protruding block having an L-shaped cross section, and the second engaging portion is a recess having an L-shaped cross section so as to engage with the protruding block.

5. The hand tool display hanger of claim 1, wherein a front side of the fixing portion has a first slot transversely formed thereon, and a front side of the fixing base has a second slot transversely formed thereon, and wherein the second slot corresponds in position to the first slot.

6. The hand tool display hanger of claim 1, wherein the hanger body is provided with a hanging hole.

7. The hand tool display hanger of claim 1, wherein the fixing base is an elastic block.

8. The hand tool display hanger of claim 1, wherein the fixing base matches the receiving space in shape.

9. The hand tool display hanger of claim 1, wherein the fixing base has a maximum dimension larger than a maximum dimension of the access opening.

10. The hand tool display hanger of claim 1, wherein the insertion hole has a cross-sectional shape different from a cross-sectional shape of the hand tool so that the hand tool can be tightly held in the insertion hole and cannot be pulled out easily, and the cross-sectional shape of the insertion hole is one of a circular shape, a rectangular shape, a pentagonal shape, a hexagonal shape, and a diamond shape.
